(19) United States
(12) Patent Application Publication
(10) Pub. No.: US 2018/0064969 A1
(43) Pub. Date: Mar. 8, 2018

(54) PHOTOLUMINESCENT SAFETY HARNESS ADAPTER

(71) Applicant: GUIDING GLOW, LLC, Eastvale, CA (US)

(72) Inventor: Rigoberto Lopez, Long Beach, CA (US)

(21) Appl. No.: 15/260,231

(22) Filed: Sep. 8, 2016

(51) Int. Cl. A62B 35/00; F21K 2/00; G02B 5/12

(52) U.S. Cl. CPC A62B 35/0025; G02B 5/12; F21K 2/00

(57) ABSTRACT

A photoluminescent safety harness adapter is provided for use with existing body harnesses. The harness adapter includes a backing configured to be wrapped around a shoulder strap of the body harness, an elongated, passive photoluminescent strip attached to the top side of the backing, and one or more light reflectors fixed on the photoluminescent strip. The backing may be inherently flame resistant and acid resistant through aramid fibers, or the backing may be treated with flame retardant. When the safety harness adapter is wrapped around the shoulder strap of the body harness, the top side and bottom side of the backing are fastened together to hold the harness adapter in place. If low light conditions arise, the light reflectors on the photoluminescent strip provide increased visibility, and if sudden darkness occurs, the photoluminescent portions of the elongated strip emit stored light.

### BACKGROUND

The present invention generally relates to safety equipment, and more particularly relates to a photoluminescent safety harness adapter for use with a body harness.

In the construction, mining, oil and gas, and related industries, fall protection systems are a necessity. Long working hours, fatigue, complacency, changes of attitude, poor work-life balance, and dangers present in the industries all lead to increased risk of a worker falling and injuring themselves while on the job. As a result, workers are generally required to wear body harnesses for safety in event of emergency or evacuation. As fire breakouts are also a common problem in these industries, body harnesses typically need to be fire-resistant in compliance with various National Fire Protection Agency (NFPA) standards (e.g. NFPA 1971, NFPA 1977, NFPA 2112, and NFPA 1975).

However, when workers are underground or in other confined spaces, sudden darkness creates an additional, unexpected danger, and a worker's visibility can be vital to their safety. While it is known for workers to use conventional lighting devices such as flash lights, light-emitting hats, belts, and other clothing with built-in power supplies to enhance visibility, such devices require workers to hold or wear additional components separate from their body harnesses. This requirement can be detrimental in sudden darkness situations, where workers may misplace these devices, batteries in the devices may run out, or workers may have from the beginning forgotten to wear these devices in addition to the harness. An adapter for conventional body harnesses to enhance worker visibility is therefore desirable.

Hence, a need exists for safety equipment that adapts a worker's body harness for low light and sudden darkness situations by providing enhanced visibility, while also remaining flame resistant to be compliant with NFPA standards. The present invention meets this and other needs.

### SUMMARY OF THE INVENTION

The present invention provides a passive, photoluminescent and reflective safety harness adapter that can be securely wrapped around the shoulder straps of existing body harnesses. The safety harness adapter includes small retroreflective areas that enhance visibility in low light situations, and delivers exceptional, high performance glow-in-the-dark illumination that provides increased user visibility in sudden dark conditions. The safety harness adapter includes a fire-resistant backing with fibrous threading in compliance with NFPA standards, and provides acid resistance and improved durability. As a result, the present invention improves worker safety, does not require workers to bring or wear additional light-emitting devices separate from the harness that can be easily misplaced, forgotten, or drained of power, and increases the longevity of the body harness.

Accordingly, a photoluminescent safety harness adapter is provided that includes a fire-resistant and acid-resistant backing configured to be wrapped around a shoulder strap of a body harness and fastened in place. The harness adapter includes an elongated, passive photoluminescent strip attached to the top side of the backing, and one or more light reflectors fixed on the photoluminescent strip. If low light conditions arise, the light reflectors on the photoluminescent strip provide increased visibility, and if sudden darkness occurs, the photoluminescent portions of the elongated strip emit stored light.

The harness adapter may further include a utility pocket for holding writing utensils and other small tools. The utility pocket is attached to the top side of the backing adjacent to the backing's left or right side and includes an opening facing the photoluminescent strip. The harness adapter further includes hardware, such as a D-ring, configured to hold a connecting device (e.g. a lanyard) attached to the body harness. The hardware is connected to either the top or bottom side of the backing adjacent to either the backing's left and right sides.

These and other features and advantages of the present invention will become apparent from the following detailed description of preferred embodiments which, taken in conjunction with the accompanying drawings, illustrate by way of example the principles of the invention.

### BRIEF DESCRIPTION OF THE DRAWINGS

FIG. 1 is a perspective view of a body harness worn by a worker including shoulder straps on each of which is wrapped a photoluminescent safety harness adapter according to a preferred embodiment of the present invention.

FIG. 2 is a rear elevational view of the body harness with photoluminescent safety harness adapters depicted in FIG. 1.

FIG. 3 is a top plan view of a preferred embodiment of the photoluminescent safety harness adapter in its fastened configuration.

FIG. 4 is a top plan view of the photoluminescent safety harness adapter of FIG. 3 in its unfastened configuration.

FIG. 5 is a bottom plan view of the photoluminescent safety harness adapter illustrated in FIG. 4.

FIG. 6 is a top plan view of the photoluminescent safety harness adapter of FIG. 3 further including a utility pocket.

FIG. 7 is a top plan view of the photoluminescent safety harness adapter of FIG. 6 in its unfastened configuration.

FIG. 8 is a bottom plan view of the photoluminescent safety harness adapter depicted in FIG. 6 in its fastened configuration.

### DETAILED DESCRIPTION OF THE PREFERRED EMBODIMENTS

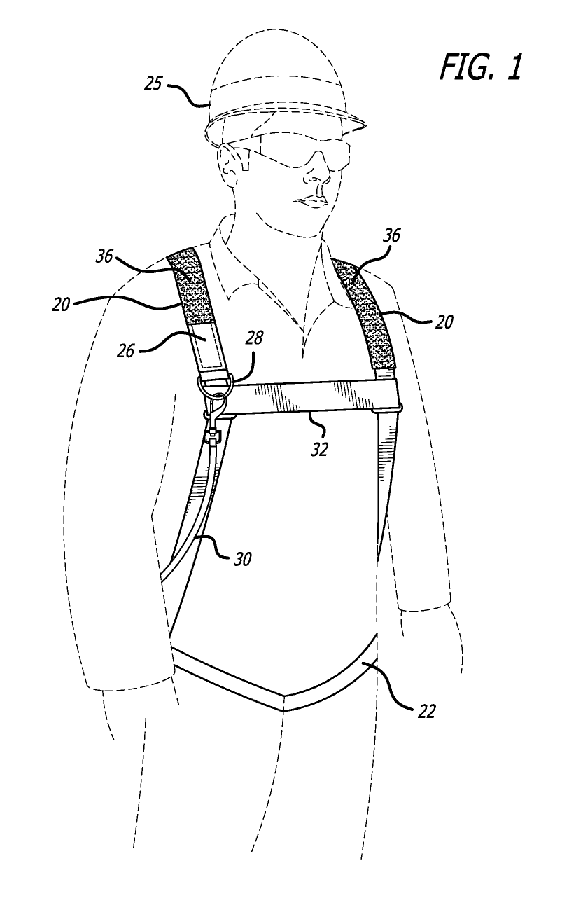

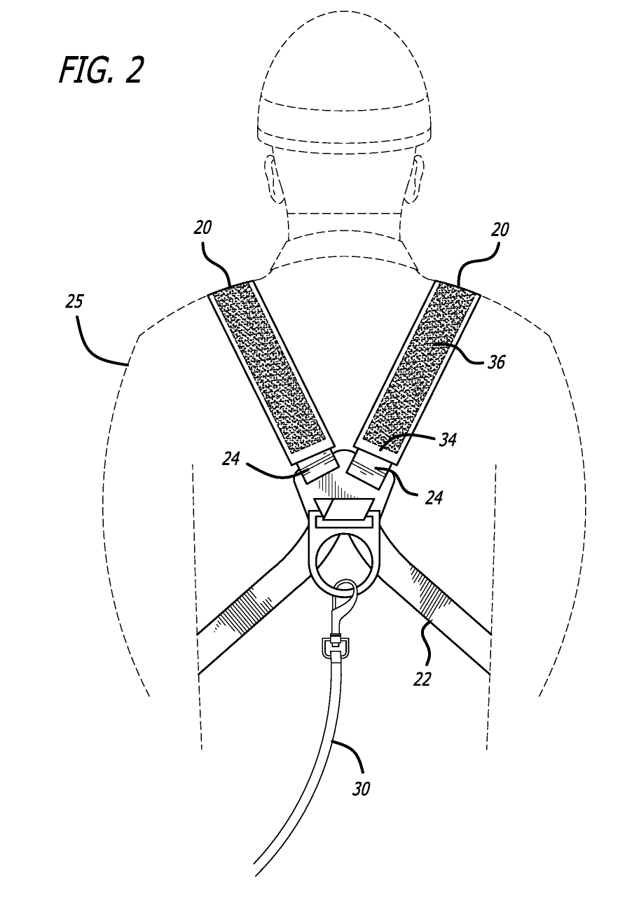

Referring FIGS. 1 and 2, a photoluminescent safety harness adapter 20 is provided that is configured to be wrapped around a strap of a body harness 22, preferably a shoulder strap 24, to provide increased visibility from both the front and the rear sides of the worker 25. Workers are not required to purchase new body harnesses, thereby saving costs. The harness adapter 20 is reflective and photoluminescent, enabling it to be easily seen in low light and sudden darkness conditions. Moreover, the photoluminescent safety harness adapters are passive in that they do not require a separate power source to constantly power the adapters, thus providing additional cost and energy savings over active electrical devices such as electroluminescent lamps, and lowering the risk of safety issues that may arise in sudden darkness situations as a result of dead batteries or other loss of power to the device.

In a preferred embodiment of the present invention, the photoluminescent safety harness adapters 20 are worn on both shoulder straps 24 of the body harness 22, they are fire-resistant and acid-resistant, and they are phosphorescent to glow in sudden darkness. The safety harness adapter may include an optional utility pocket 26 to carry writing utensils, a utility knife, or other tools. The utility pocket is especially advantageous for workers wearing disposable coveralls or suits underneath their body harness, such as garments branded under the trademark Tyvek®, since these workers do not need to open their garment (i.e. breach the “paper suit barrier”) to retrieve their tools and thereby possibly expose themselves to contaminants such as particulate dust and other solid and non-solid matter in the area. Additionally, the safety harness adapters may include attached hardware 28, for example D-rings, for positioning or holding a connecting device 30 attached to the body harness in fall protection systems, such as a lanyard, when the connecting device is not in use. The hardware transfers the weight of the lanyard from the sternum strap 32 of the body harness to the safety harness adapter, thereby maintaining the sternum strap in its correct position.

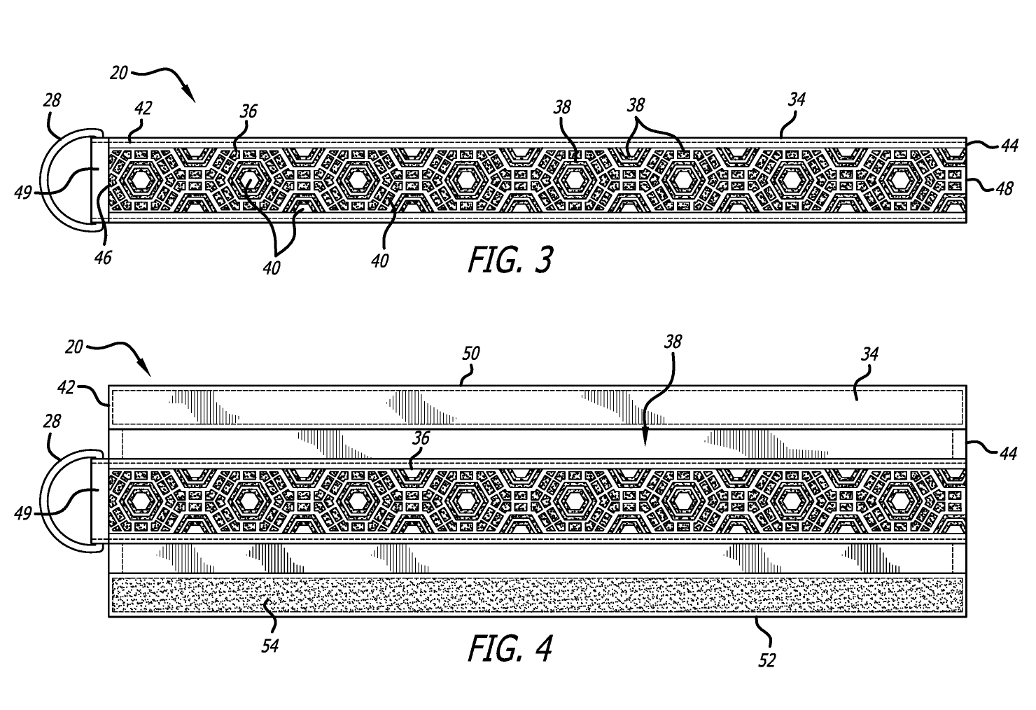

FIGS. 3-5 and 8 more closely illustrate the preferred embodiment of the photoluminescent safety harness adapter 20. As shown in FIG. 3, the safety harness adapter includes a fire-resistant backing 34 configured to wrap around a strap 24 of the body harness 22. The backing 34 is a fabric that may be inherently flame-resistant, for example comprised of aramid fibers under the brand Kevlar®, or the backing may be treated with flame retardant. An elongated photoluminescent strip 36 is attached to the top side 38 of the backing that substantially covers the top side of the backing in its fastened configuration. “Substantially” as used herein may include the entire backing 34, as illustrated in FIGS. 3-5, most of the backing as illustrated in FIG. 2, or a majority of the backing such as that shown in FIG. 6. The strip 36 may be lime-yellow or any other color conducive to visibility, and is passive in that it does not require an active source of electricity or power built into the backing to emit light. One or more light reflectors 38, preferably retroreflective to maximize reflected light, are fixed onto the photoluminescent strip, defining photoluminescent areas 40. While FIG. 3 illustrates a plurality of light reflectors 38 being arranged in a hexagonal pattern, other patterns of light reflectors may be used. Hardware 28 for holding the unused connecting device 30 may be attached to one of the left or right sides 42, 44 of the backing adjacent to one of the left or right sides 46, 48 of the photoluminescent strip by fabric attachment 49.

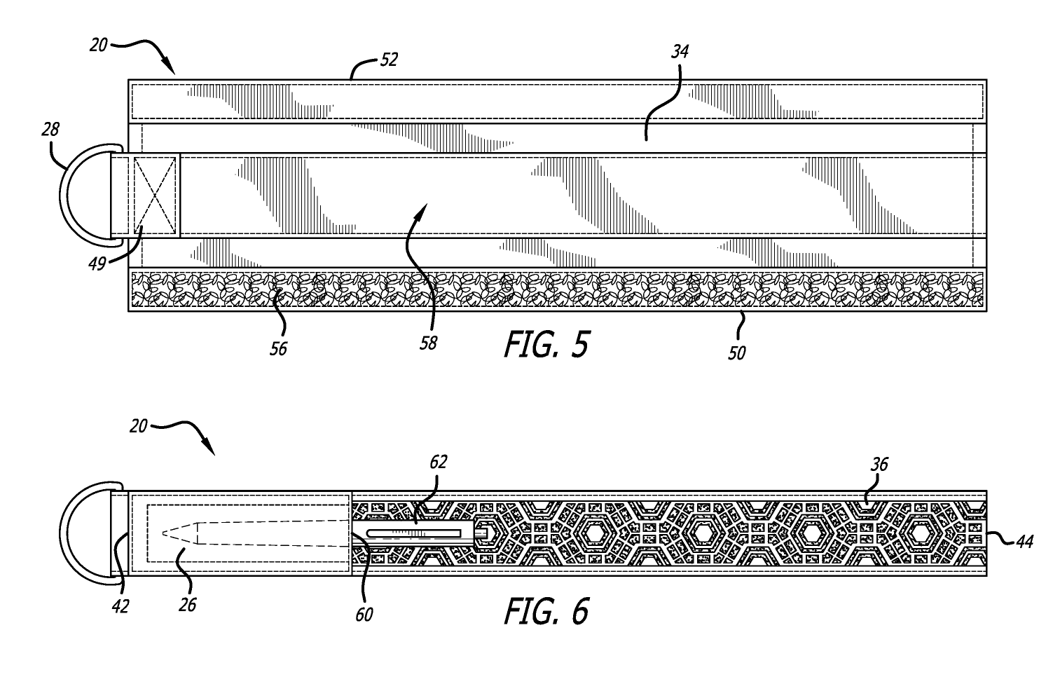

Referring now to FIGS. 4 and 5, the photoluminescent strip 36 is attached to the backing 34 between the upper and lower sides 50, 52 of the backing. Fasteners are attached to the backing adjacent to the backing's upper and lower sides to securely wrap the safety harness adapter 20 around the strap 24 of the body harness 22. For example, a hook-and-loop fastener may be employed having a hook portion 54 and a loop portion 56, in which the hook portion is attached to the top side 38 of the backing adjacent to the backing's lower side 52 as shown in FIG. 4, and in which the loop portion is attached on the bottom side 58 of the backing adjacent to the backing's upper side 50 as shown in FIG. 5. When the safety harness adapter is folded around the strap of the body harness, the hook portion and loop portion fasten together and the safety harness adapter is held in place around the strap. Alternatively, the positions and sides of the hook portion and loop portion may be reversed, or other mating fasteners such as buttons, snaps, and the like may be used. Fabric attachment 49 for connecting the hardware 28 to the backing is preferably attached on the bottom side of the backing to avoid overlapping the photoluminescent strip.

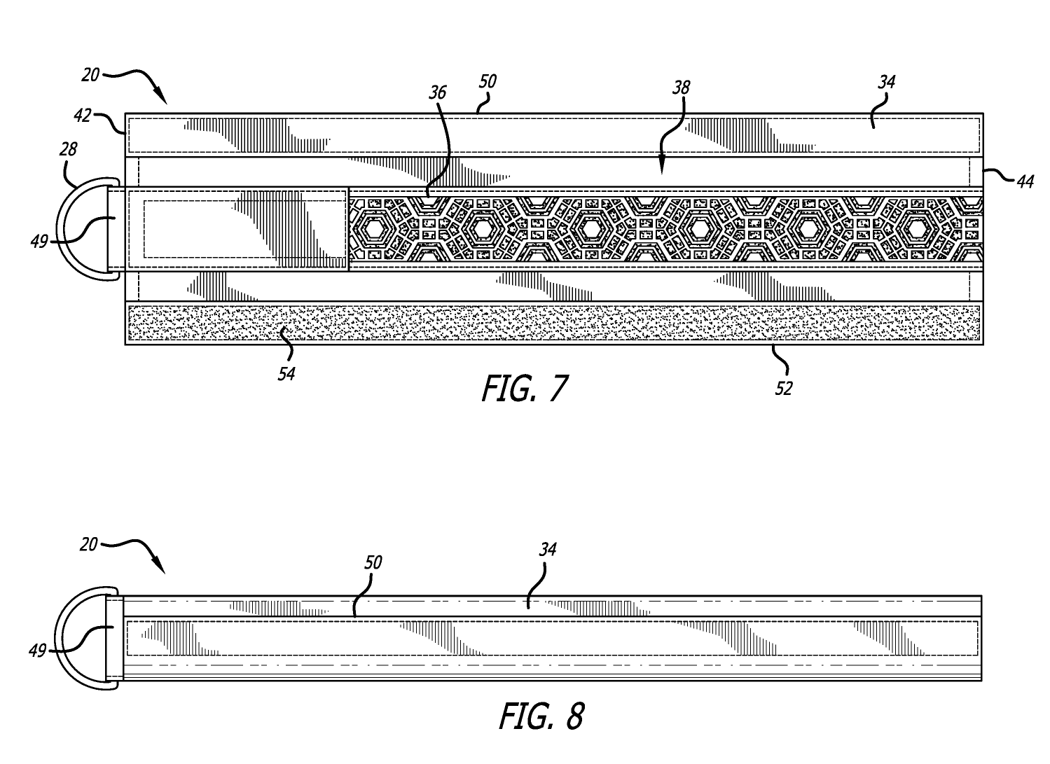

FIGS. 6 and 7 illustrate the structure of the safety harness adapter 20 with the utility pocket 26 additionally attached to the top side 38 of the backing adjacent to one of the backing's left and right sides 42, 44. In this case, the length of the elongated photoluminescent strip 36 is reduced to make room for the utility pocket on the top side of the backing such that the combined length of the photoluminescent strip and utility pocket substantially cover the backing's top side. The opening 60 of the utility pocket faces the photoluminescent strip so that when the safety harness adapter is wrapped around a shoulder strap 24 of the body harness 22, the photoluminescent strip is visible from the worker's back while the utility pocket is usable for pencils 62 and other small tools at the worker's front, as depicted in FIGS. 1 and 2. The photoluminescent strip, fasteners, hardware, and optional utility pocket of FIGS. 3 and 6 are preferably assembled to the backing with fibrous thread, such as Kevlar®, for optimal durability.

To use the photoluminescent safety harness adapter 20, a worker 25 wraps a harness adapter around each shoulder strap 24 or other strap of his or her body harness 22 and fastens together the upper and lower sides 50, 52 of the fire-resistant backing 34. The worker can then wear the body harness with attached safety harness adapter and work normally, without requiring to use separate, additional light-emitting components. If low light conditions arise, the retroreflective light reflectors 38 on the photoluminescent strip 36 provide increased visibility, and if sudden darkness occurs, the phosphorescent portions 40 of the elongated strip emit stored light. The worker can store writing utensils 62 and other small tools in the utility pocket 26 of the harness adapter, and can rest the connecting device 30 attached to his or her body harness on the hardware 28 attached to the harness adapter's backing when the connecting device is not in use. The harness adapter may be easily unfastened if so desired.

It will be apparent from the foregoing that while particular forms of the invention have been illustrated and described, various modifications can be made without departing from the spirit and scope of the invention. Accordingly, it is not intended that the invention be limited, except as by the appended claims.

What is claimed is:

1. A photoluminescent safety harness adapter for a body harness, the harness adapter comprising:
a backing configured to be wrapped around a shoulder strap of a body harness, the backing including an upper side, a lower side, a left side, a right side, a top side, and a bottom side;
an elongated, passive photoluminescent strip attached to the top side of the backing;
a light reflector fixed on the photoluminescent strip; and
means for fastening the top side of the backing to the bottom side of the backing.

2. The photoluminescent safety harness adapter of claim 1, wherein the backing and photoluminescent strip are made from aramid fibers configured to provide fire resistance and acid resistance.

3. The photoluminescent safety harness adapter of claim 1, wherein a plurality of light reflectors on the photoluminescent strip are arranged in a hexagonal pattern along the photoluminescent strip.

4. The photoluminescent safety harness adapter of claim 1, wherein the light reflector is retroreflective.

5. The photoluminescent safety harness adapter of claim 1, wherein the photoluminescent strip substantially covers the top side of the backing when the top side and bottom side of the backing are fastened together.

6. The photoluminescent safety harness adapter of claim 1, further comprising a utility pocket attached to the top side of the backing adjacent to one of the left and right sides of the backing, the utility pocket including an opening facing the photoluminescent strip.

7. The photoluminescent safety harness adapter of claim 1, further comprising hardware connected to the backing adjacent to one of the left side and right sides of the backing, the hardware configured to hold a connecting device for the body harness.

8. The photoluminescent safety harness adapter of claim 7, wherein the hardware is a D-ring.

9. The photoluminescent safety harness adapter of claim 1, wherein the means for fastening includes a hook portion attached to one of the top side and the bottom side of the backing and adjacent to one of the upper side and lower side of the backing, and a loop portion attached to the other of the top side and the bottom side of the backing and adjacent to the other of the upper side and the lower side of the backing.

10. A photoluminescent safety harness adapter for a body harness, the harness adapter comprising:
a backing configured to be wrapped around a shoulder strap of a body harness, the backing including an upper side, a lower side, a left side, a right side, a top side, and a bottom side;
an elongated, passive photoluminescent strip attached to the top side of the backing;
a plurality of light reflectors fixed on the photoluminescent strip;
means for fastening the top side of the backing to the bottom side of the backing; and
a utility pocket attached to the top side of the backing adjacent to one of the left and right sides of the backing, the utility pocket including an opening facing the photoluminescent strip.

11. The photoluminescent safety harness adapter of claim 10, wherein the backing and photoluminescent strip are made from aramid fibers configured to provide fire resistance and acid resistance.

12. The photoluminescent safety harness adapter of claim 10, wherein the plurality of light reflectors on the photoluminescent strip are arranged in a hexagonal pattern along the photoluminescent strip.

13. The photoluminescent safety harness adapter of claim 10, wherein the light reflectors are retroreflective.

14. The photoluminescent safety harness adapter of claim 10, wherein the photoluminescent strip substantially covers the top side of the backing when the top side and bottom side of the backing are fastened together.

15. The photoluminescent safety harness adapter of claim 10, further comprising hardware connected to the backing adjacent to one of the left side and right sides of the backing, the hardware configured to hold a connecting device for the body harness.

16. The photoluminescent safety harness adapter of claim 15, wherein the hardware is a D-ring.

17. The photoluminescent safety harness adapter of claim 1, wherein the means for fastening includes a hook portion attached to one of the top side and the bottom side of the backing and adjacent to one of the upper side and lower side of the backing, and a loop portion attached to the other of the top side and the bottom side of the backing and adjacent to the other of the upper side and the lower side of the backing.

18. A photoluminescent safety harness adapter for a body harness, the harness adapter comprising:
a backing configured to be wrapped around a shoulder strap of a body harness, the backing including an upper side, a lower side, a left side, a right side, a top side, and a bottom side;
an elongated, passive photoluminescent strip attached to the top side of the backing;
a plurality of light reflectors fixed on the photoluminescent strip;
means for fastening the top side of the backing to the bottom side of the backing;
a utility pocket attached to the top side of the backing adjacent to one of the left and right sides of the backing, the utility pocket including an opening facing the photoluminescent strip; and
hardware connected to the backing adjacent to one of the left side and right sides of the backing, the hardware configured to hold a connecting device for the body harness.

19. The photoluminescent safety harness adapter of claim 18, wherein the backing and photoluminescent strip are made from aramid fibers configured to provide fire resistance and acid resistance.

20. The photoluminescent safety harness adapter of claim 18, wherein the photoluminescent strip substantially covers the top side of the backing when the top side and bottom side of the backing are fastened together.
